(19) United States
(12) Patent Application Publication
(10) Pub. No.: US 2013/0270783 A1
(43) Pub. Date: Oct. 17, 2013

(54) STEERABLE FOAM SLIDER

(71) Applicant: Kaj Gyr, Nelson (CA)

(72) Inventor: Kaj Gyr, Nelson (CA)

(21) Appl. No.: 13/862,137

(22) Filed: Apr. 12, 2013

Related U.S. Application Data
(60) Provisional application No. 61/624,008, filed on Apr. 13, 2012.

(51) Int. Cl. B62B 15/00

(52) U.S. Cl. CPC B62B 15/00
USPC 280/18

(57) ABSTRACT

A snow gliding device includes a flexible bottom layer formed as a bellows, and plural chassis, each being coupled to the body, wherein the interaction of the chassis and the bottom layer facilitates steering of the device by a rider. The bottom layer is formed with an arc shape.

### CROSS-REFERENCE TO RELATED APPLICATIONS

This application claims the benefit of U.S. Provisional Patent Application Serial No. 61/624,008 filed Apr. 13, 2012, which application is incorporated herein by reference for all purposes.

### BACKGROUND

Despite the popularity of sledding, sleds have not evolved much in the last two decades. It's safe to say that most sleds offer little or no steering or braking, which makes them more dangerous and less fun than steerable sleds. Even the so-called “GT Racer” type of sled, despite having a steering mechanism of sorts, is notoriously difficult to control.

Sleds made out of foam (with a slippery polyethylene surface bonded to the base) are very popular, largely because they are inexpensive to manufacture. Foam sleds are even more difficult to steer than other sleds however, as there is no means for initiating a turn aside from dragging a hand or foot.

Standard sleds often include a variety of hinges and articulations to facilitate turning, but these mechanisms are not practical on a foam sled for a variety of reasons, mostly having to do with the fragility of foam and its inherent thickness. On foam sleds hinges don't function well at all. In addition, they are more prone to breaking, being that all the forces are focused on the area around the hinge. In addition, such sleds would require totally different processes for manufacturing, thereby increasing the overall cost. Thus the need for a simple, durable, easy to manufacture, and inexpensive steering mechanism for foam sleds.

The present invention includes an integrated, curvilinear bellows-style region that allows for articulation of the front and back portions of the sled, thereby allowing for precise steering.

Advantages of the present inventive concept:
Optimal performance in powder snow and hardpack.
Portable and easy to carry.
Maneuverable.
Good in bumps due to flexible and/or articulated portions.
Easy to manufacture using standard foam sled methods.
Compact packaging (due to foldability).
Unlike sleds with mechanical hinges, the forces are distributed more evenly, making the Steerable Foam Slider both easier to handle and less likely to break.

### BRIEF DESCRIPTION OF THE DRAWINGS

FIG. 1 shows a plan view of the Steerable Foam Slider with hand/footholds and handholds

FIG. 2 shows a bottom view of the Steerable Foam Slider

FIG. 3 shows a plan view of the Steerable Foam Slider with travel limiter flexing as it would for turning.

FIG. 4 shows a bottom view of the Steerable Foam Slider flexing for turning.

FIG. 5 shows a perspective view of the Steerable Foam Slider being folded.

FIG. 6 shows a close-up perspective view of the upward arc.

FIG. 7 shows a perspective view of the Steerable Foam Slider with handholds and no seat.

FIG. 8 shows a perspective view of the Steerable Foam Slider with handholds and angled footrest.

FIG. 9 shows a seated position.

FIG. 10 shows a kneeling position.

FIG. 11 shows a plan view of an asymetric Steerable Foam Slider with dampener.

FIG. 12 shows a plan view of a symetric Steerable Foam Slider with radiused adjoining sides.

FIG. 13 shows a plan view of a foam slider with contiguous chassis.

### REFERENCE NUMERALS IN DRAWINGS

2—Bellows

4—Gap

6—Bottom layer

8—Travel limiter

10—Upward Arc

12—Hand/foot holds

14—Foot straps

16—Handholds

18—Angled Footrest

20—Sled chassis

22—Dampener

### Description

For the chassis, molded or formed foam, plastic or any robust material may be used. Sandwich construction involving laminated foam is also possible. Foam is perhaps the most suitable for limiting manufacturing costs. Methods similar to those which are currently used for building foam sleds may be employed.

However, unlike standard foam sleds that have one uniform chassis, the present invention is formed from plural chassis, each being suitably coupled to a bottom layer. The bottom layer is formed as a flexible bellows due to a gap and upward arc formed at its lateral margins. The upward arc also allows the rear chassis to glide along the snow without plowing through it, as its shape deflects the snow downward, like the front portion of a ski. Preferably it has more of an upward arc than shown in FIG. 4.

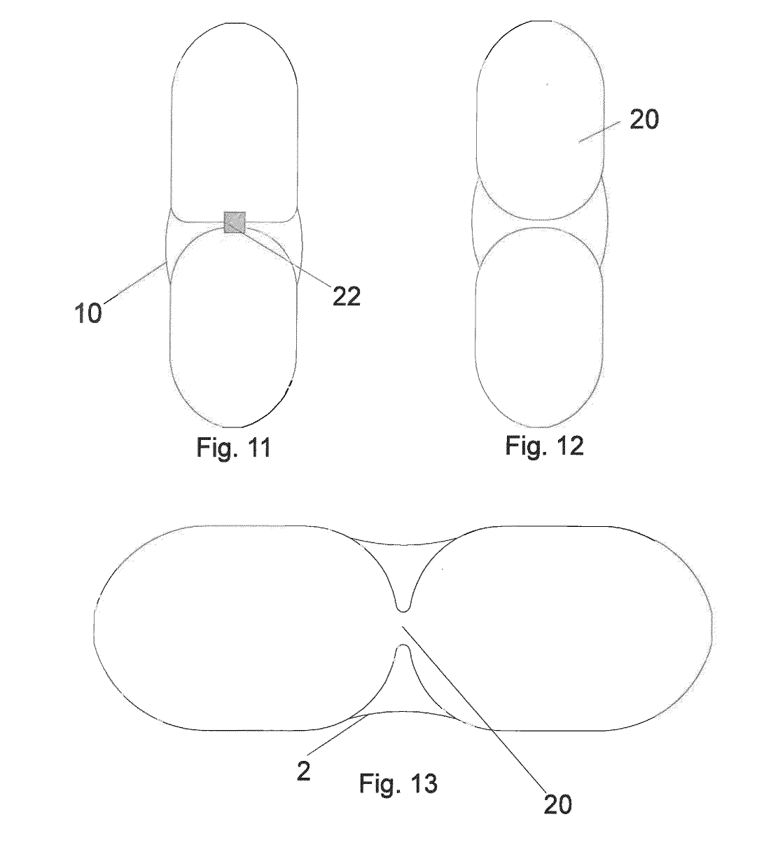

The upward arc of the bottom layer can be either molded or heat formed (or other methods germane to the art) and is preferably contiguous with the bottom layer. A variety of flexible and slippery plastics, notably polyethylene (currently used for foam sleds), is suitable material for the bottom layer. In one embodiment, two chassis are bonded to the bottom layer using methods currently employed for foam sleds. A wide variety of shapes for the chassis are possible (FIG. 11 is asymetric, while FIG. 12 is symetric), and the widths of the chassis are generally in the range of 8-20 inches.

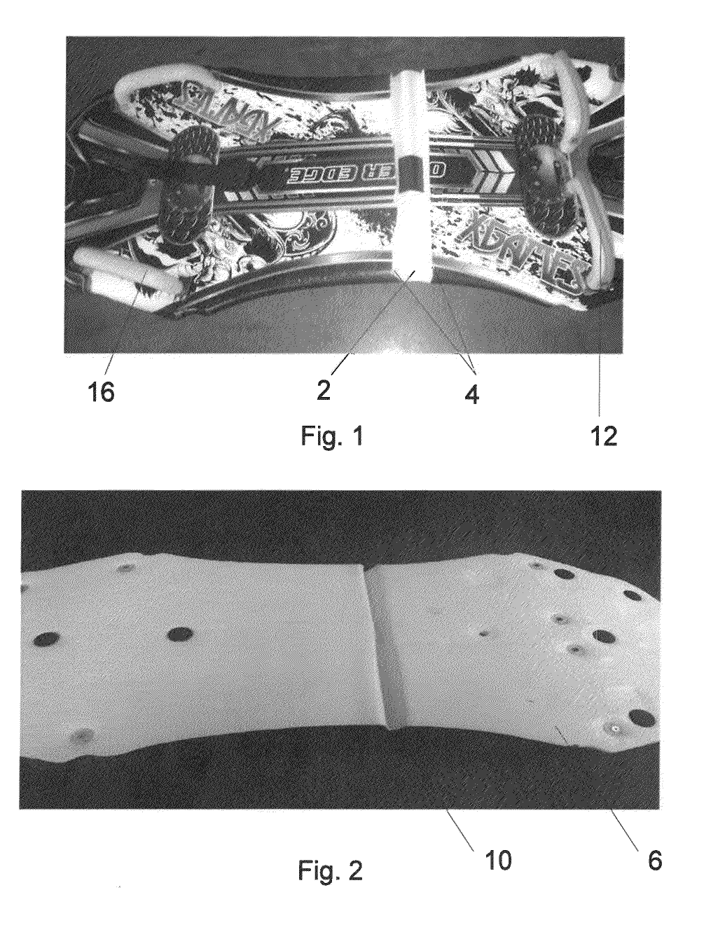

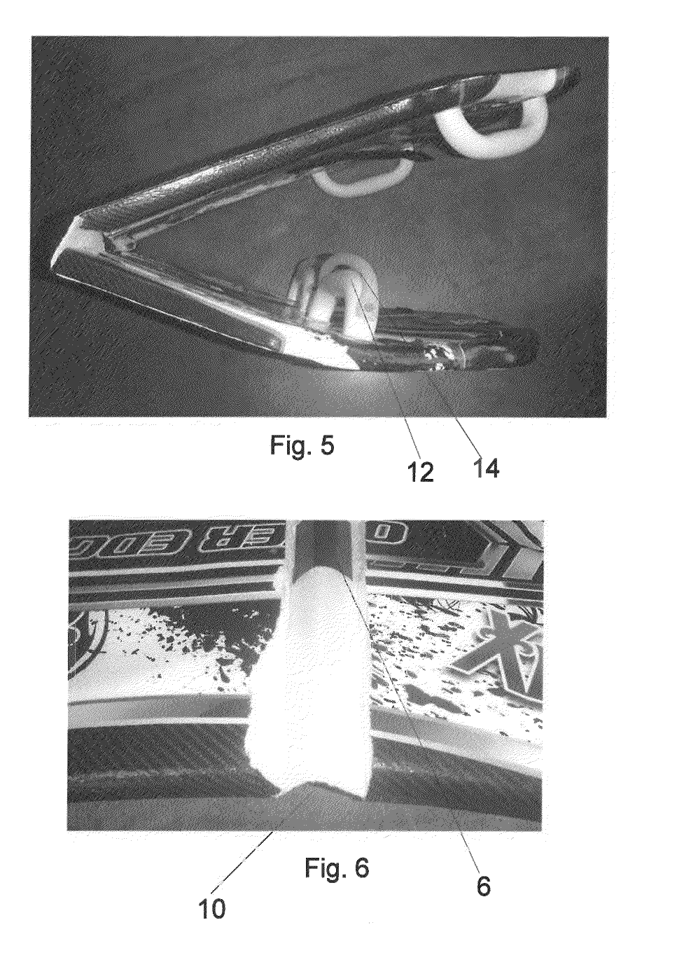

By varying the radius of the two chassis adjacent the bellows formed by the bottom layer (forward section of the rear chassis and aft section of the front chassis), and varying the amount of upward arc of the bellows, the bellows can be adjusted to a pre-selected amount of flex for turning. For example, a short distance of the bottom layer (between the chassis) at the center of two chassis coupled with a longer distance of the bottom layer towards the edges of the two chassis yields a very steerable sled (as in FIG. 12), while configurations akin to FIGS. 1-6 and FIG. 11 yield a less steerable sled.

The slack of the upward arc at its lateral portions relative to the closer gap in the center is what allows the two chassis to pivot relative to one another. If the gap is uniform along its length it is very difficult to steer, as forward pressure on one side of the front chassis simply extends that side of the front portion, without folding the other side. This means the sled continues in a straight line. Only by altering the distance between the front and rear portions (with the lesser distance being towards the centerline of a longitudinal axis) is it possible to steer. Polyethylene is very flexible, and remains so even at cold temperatures or with repeated cycles, thus it is an ideal material for allowing the bellows to flex. As long as the chassis foam is flexible, it may be layered on the bottom layer between the two chassis. Flexible neoprene-type foam could be used for the chassis, continuing in between the two sections. Despite having continuous foam, proper flexing of the bellows will still happen as long as they are shaped with an upward arc, pleats, or folds.

This allows for bending or deformation at the center.

Tracking of the Steerable Foam Slider is optimized by including profiles on the bottom of the sled, either integrated with the bottom layer, or sticking through it from above. Keels, small ridges, grooves, fins—anything which limits lateral slippage is fine. The polyethylene normally used for bottom layers can be extruded or formed with said features integrated.

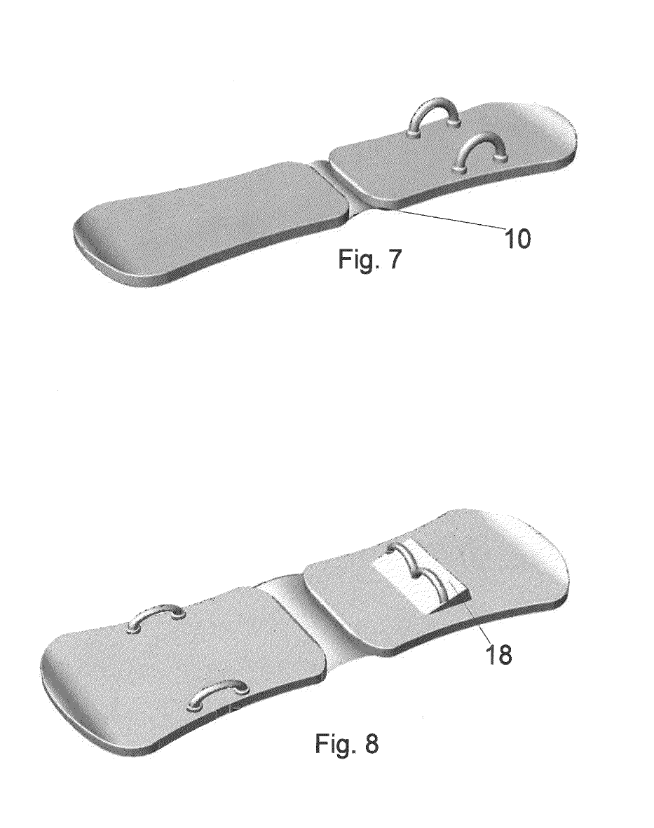

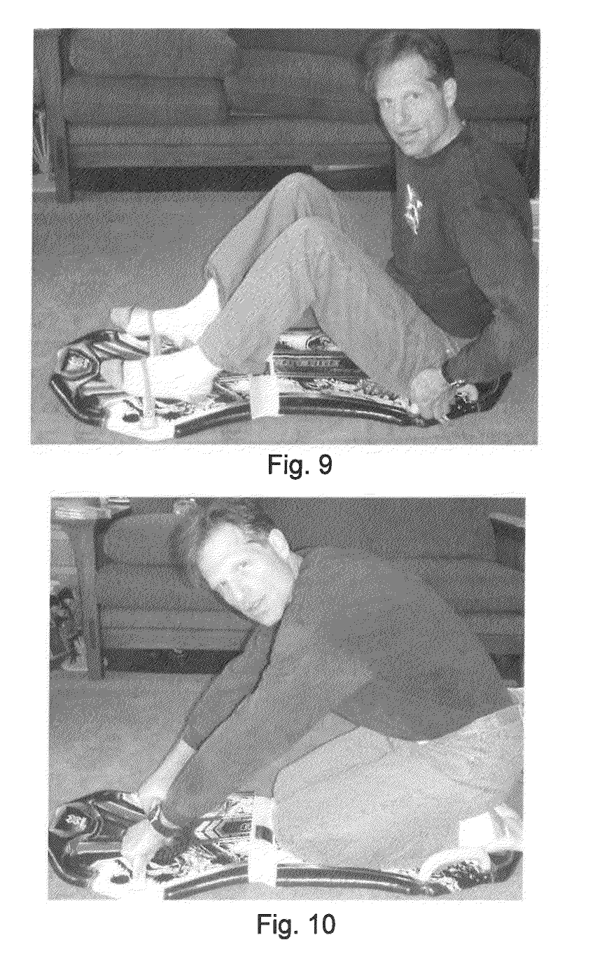

Depending on the shape of the two chassis where they abut each other, as well as the shape of the upward arc, a travel limiter may be placed between the two chassis. Made from an elastic material and attached to the rear portion of the front chassis and the front portion of the rear chassis, the travel limiter is most needed for relatively straight abutting edges (as in FIGS. 1-8). It would not be necessary for curvilinear abutting edges (as in FIGS. 11-12), as the center portion creates a pivot point for the bellows to hinge around.

A dampener (as in FIG. 11) may be placed between the two chassis to further dampen steering forces, but it is not necessary. The dampener could be removable, co-molded and/or attached with methods germane to the art, and is ideally an elastomeric material with a durometer similar to neoprene. Alternatively, foam of varying durometers can be placed or co-molded in the bellows area, as in FIG. 13.

FIG. 13 shows a foam slider with contiguous chassis. The foam or chassis material bridges the front and rear portions, flexing accordingly. It may be of variable thickness and/or laminated from variable-durometer materials. It may also have pleats or folds on the X-axis and/or Y-axis to enhance flexing. The hourglass shape allows the bellows to flex naturally, and may be exaggerated or more rectilinear.

As the Steerable Foam Slider may be used while the rider is sitting or kneeling, a variety of hand/footholds and handholds may be affixed to the chassis using methods germane to the art. FIGS. 1, 5, and 7-8 show a variety of configurations for hand/footholds. In addition, an angled footrest (as in FIG. 8) or other means for increasing comfort may be affixed. Notably, a seat which provides more padding is a nice option. Such units may be affixed to the chassis with Velcro (to allow for adjustability) or other methods germane to the art.

### Operation

Use of the Steerable Foam Slider is similar to that of a standard foam sled. One can either be seated or kneeling. Pivoting the front section relative to the rear is intuitive and is done simply by pulling/pushing on either side of the hand/footholds. Depending on the width of the chassis and snow conditions, a certain amount of leaning may be combined with the pivoting motion. Folding the sled is simple and easy—just fold at the bellows in one quick motion.

### Additional Embodiments may Include Any Combination of the Following

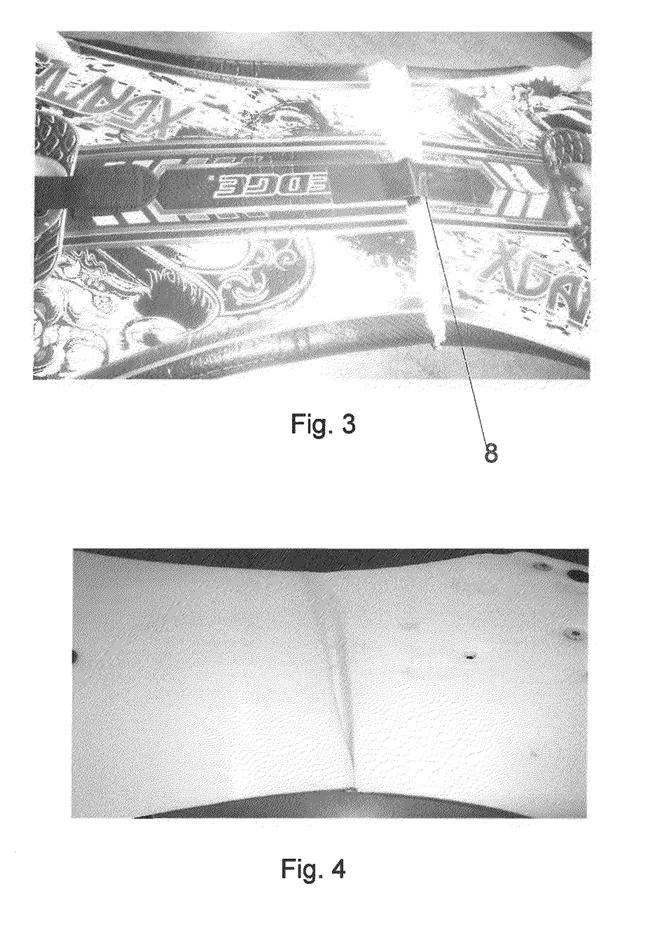

Pleats or distinct folds instead of bellows.
A mechanism for easily detaching the front and rear boards.
A means of adjusting the flex (compression and elongation) of the bellows, by means of a travel limiter (FIG. 3) or dampener (FIG. 11) affixed between the chassis.
Varying widths and shapes of the front and back chassis.
Various bottom profiles; ridges, indentations, keels, fins, or ribbing in order to control lateral sliding.
Incorporation of the bellows-style mechanism into a non-foam sled or rigid-bottomed sleds.
A continuous foam layer (continuing between the chassis, as in FIG. 13) of constant or variable thickness which flexes with the bellows
Any combination of the above.

### CONCLUSIONS, RAMIFICATIONS, AND SCOPE

Clearly there are a variety of forms the Steerable Foam Slider may take. Versions made specifically for Freestyle, Carving, Hardpack, Powder, and Racing could all incorporate various forms of flexing, thickness, weight, sidecut, adjustability, bottom profiles, and bellows. Materials and methods germane to the art may be liberally employed in various combinations. The steering mechanism described herein has potential applications in water sports. Boogie Boards™ and various watercraft may also use similar steering mechanisms. Thus the scope of the invention should not be limited to the specific embodiments described in this specification, but rather to the range of options the unique steering mechanism allows.

I claim:

1. A snow gliding device, comprising:
a flexible bottom layer formed as a bellows; and
plural chassis, each being coupled to the body, wherein the interaction of the chassis and the bottom layer facilitates steering of the device by a rider.

2. The device of claim 1, wherein the bottom layer is formed with an arc shape.
